(19) United States
(12) Patent Application Publication
(10) Pub. No.: US 2020/0164562 A1
(43) Pub. Date: May 28, 2020

(54) RUBBER SHEET MONITORING APPARATUS AND RUBBER SHEET MONITORING METHOD

(71) Applicant: Kabushiki Kaisha Kobe Seiko Sho (Kobe Steel, Ltd.), Kobe-shi (JP)

(72) Inventors: Eiji TAKAHASHI, Kobe-shi (JP); Chitaka MANABE, Kobe-shi (JP); Akira KONISHI, Takasago-shi (JP); Hodaka MIURA, Kobe-shi (JP)

(73) Assignee: Kabushiki Kaisha Kobe Seiko Sho (Kobe Steel, Ltd.), Kobe-shi (JP)

(21) Appl. No.: 16/611,301

(22) PCT Filed: Apr. 9, 2018
(86) PCT No.: PCT/JP2018/014868

§ 371 Date: Nov. 6, 2019

(30) Foreign Application Priority Data
May 25, 2017 (JP) 2017-103452

(51) Int. Cl. B29C 48/92; B29C 48/00; B29C 48/07; G01B 11/30; G01B 11/06

(52) U.S. Cl. CPC B29C 48/92; B29C 48/0022; B29C 48/07; G01B 11/303; B29C 2948/92428; G01B 11/306; G01B 11/0691; B29C 2948/92104; B29C 2948/92152; G01B 11/0608

(57) ABSTRACT

A rubber sheet monitoring apparatus (1) comprises a first imaging unit (11), a second imaging unit (2), a first generation unit (142) and a second calculation unit (146). The first imaging unit successively acquires images of a first optical cutting edge (CL1) formed on a front surface of a rubber sheet (6). The second imaging unit successively acquires images of a second optical cutting edge (CL2) formed on a back surface of the rubber sheet. The first generation unit performs, for each of the successively acquired images of the first optical cutting edge, generation of first data (D1) representing height variation of a widthwise cross-sectional edge of the rubber sheet using the image of the first optical cutting edge, and performs, for each of the successively obtained images of the second optical cutting edge, generation of second data (D2) representing height variation of a widthwise cross-sectional edge of the rubber sheet using the image of the second optical cutting edge. The second calculation unit calculates, using first data and second data for a same cross-section, the thickness of the rubber sheet at the cross-section.

### TECHNICAL FIELD

The present invention relates to a technique for monitoring the thickness and other properties of a rubber sheet being fed after having been formed into a sheet shape.

### BACKGROUND ART

Raw rubber and compounding agents, after having been kneaded in a kneader, are conveyed in mass to a rubber sheet forming machine (for example, a roller extruder), and the rubber sheet forming machine compresses the mass into a sheet shape and feeds it out. If the rubber sheet fed out of the rubber sheet forming machine has an uneven thickness, it may cause troubles in the subsequent steps (for example, in the step of cutting the rubber sheet and stacking the cut pieces of the rubber sheet, the stacking operation may be hindered) or it may degrade the quality of products (for example, a tire) made of the rubber sheet.

As can be seen from the above, it is important to monitor the thickness of the rubber sheet fed out of the rubber sheet forming machine. Accordingly, there have been suggested techniques for measuring the thickness of the rubber sheet fed out of the rubber sheet forming machine. For example, a rubber sheet thickness variation measuring apparatus disclosed in Patent Literature 1 measures the thickness of a rubber sheet being conveyed after having been formed by extrusion. The apparatus includes a measuring means for measuring the thickness of the rubber sheet being conveyed, in the width and longitudinal directions of the rubber sheet. The measuring means includes a plurality of laser displacement sensors, which are disposed in such a way as to face one another across the rubber sheet, for detecting the extent of displacement of the front surface and the back surface of the rubber sheet, an arithmetic means for calculating the thickness of the rubber sheet based on the detected extents of displacement of the front surface and the back surface of the rubber sheet, and a reciprocating movement means for reciprocatingly moving the plurality of laser displacement sensors, disposed opposite one another, in the width direction of the rubber sheet while keeping their relative positions unchanged. The rubber sheet thickness variation measuring apparatus measures the thickness of the rubber sheet being conveyed, in the longitudinal and width directions of the rubber sheet, by the reciprocating movement means reciprocatingly moving the plurality of laser displacement sensors in the width direction of the rubber sheet, allowing the measuring means to measure the thickness of the rubber sheet.

A silica-containing rubber sheet is a rubber sheet which contains silica as a reinforcing agent. Silica, which is hard, may destroy the uniformity of thickness of the rubber sheet fed out of the rubber sheet forming machine. Silica is distributed over the entirety of the rubber sheet. Therefore, the present inventors have found that in the case where the rubber sheet fed out of the rubber sheet forming machine is a silica-containing rubber sheet, it is undesirable to leave any portion not measured for thickness and, therefore, it is necessary to measure the thickness of the rubber sheet over its entire surface.

The rubber sheet thickness variation measuring apparatus disclosed in Patent Literature 1 measures the thickness of the rubber sheet being conveyed, while reciprocatingly moving the measuring means in the width direction of the rubber sheet. This makes it impossible to measure the thickness of the rubber sheet over its entire surface. In order to improve the accuracy of detecting defects of the rubber sheet, it is preferable to measure the thickness of the rubber sheet over its entire surface. In addition, the evaluation value for unevenness of the front surface of the rubber sheet and the width of the rubber sheet, if measured, could also be conveniently used to judge whether the rubber sheet is defective.

### CITATION LIST

### Patent Literature

Patent Literature 1: Japanese Unexamined Patent Publication No. 2016-23077

### SUMMARY OF INVENTION

It is an object of the present invention to provide a rubber sheet monitoring apparatus and a rubber sheet monitoring method capable of measuring the thickness of a rubber sheet, the evaluation value for unevenness of a front surface of the rubber sheet, and the width of the rubber sheet over the entire surface of the rubber sheet.

A rubber sheet monitoring apparatus according to a first aspect of the present invention comprises: a first acquisition unit for successively acquiring images of a first optical cutting edge, synchronously with a feeding speed of a rubber sheet which is fed after having been formed into a sheet shape, the images of the first optical cutting edge being formed by irradiating one surface of the rubber sheet with a first sheet beam extending in a width direction of the rubber sheet; a second acquisition unit for successively acquiring images of a second optical cutting edge, synchronously with the feeding speed of the rubber sheet, the images of the second optical cutting edge being formed by irradiating the other surface of the rubber sheet with a second sheet beam extending in the width direction of the rubber sheet; a first generation unit for performing, for each of the successively acquired images of the first optical cutting edge, generation of first data representing height variation of a widthwise cross-sectional edge of the rubber sheet using the image of the first optical cutting edge, and performing, for each of the successively acquired images of the second optical cutting edge, generation of second data representing height variation of a widthwise cross-sectional edge of the rubber sheet using the image of the second optical cutting edge; a first calculation unit for calculating, using the first data, an unevenness evaluation value of the one surface of the rubber sheet; a second calculation unit for calculating, using first data and second data for a same cross-section, a thickness of the rubber sheet; and a third calculation unit for calculating, using the first data, a width of the rubber sheet.

### BRIEF DESCRIPTION OF DRAWINGS

FIG. 1 is a diagram for explaining a process in which a rubber sheet monitoring apparatus according to an embodiment is applied, the process beginning with a kneading step and ending with a rubber sheet cutting step.

FIG. 2 is a block diagram showing a configuration of the rubber sheet monitoring apparatus according to the embodiment.

FIG. 3 is a schematic view showing a first example arrangement of a first light source, a first imaging unit, a second light source, and a second imaging unit.

FIG. 4 is a plan view of a rubber sheet having a front surface on which a first optical cutting edge is formed by a first sheet beam being irradiated thereon.

FIG. 5 is a plan view of the rubber sheet having a back surface on which a second optical cutting edge is formed by a second sheet beam being irradiated thereon.

FIG. 6 is a schematic view showing a second example arrangement of the first light source, the first imaging unit, the second light source, and the second imaging unit.

FIG. 7 is a schematic view showing arrangement of three first light sources and three second light sources.

FIG. 8 is a schematic view showing arrangement of three first imaging units and three second imaging units.

FIG. 9 is a plan view of the front surface of the rubber sheet on which first optical cutting edges are formed by first sheet beams respectively emitted from the three first light sources.

FIG. 10 is a plan view of the back surface of the rubber sheet on which second optical cutting edges are formed by second sheet beams respectively emitted from the three second light sources.

FIG. 11 is a diagram for explaining an example of first data and second data.

FIG. 12 is a diagram for explaining an example of third data and fourth data.

FIG. 13 is a diagram for explaining an example of the first data.

FIG. 14 is a schematic view showing an example of a 3D image of the rubber sheet generated by an image generation section.

FIG. 15 is a schematic view showing an example of a 2D image of the rubber sheet generated by the image generation section.

FIG. 16 is a schematic view showing another example of the 2D image of the rubber sheet generated by the image generation section.

FIG. 17 is a schematic graph showing the unevenness of the front surface of the rubber sheet at a cross-section taken along a first straight line.

FIG. 18 is a schematic graph showing the unevenness of the front surface of the rubber sheet at a cross-section taken along a second straight line.

FIG. 19 is a schematic graph showing the unevenness of the front surface of the rubber sheet at a cross-section taken along a third straight line.

FIG. 20 is a schematic graph showing the unevenness of the front surface of the rubber sheet at a cross-section taken along a fourth straight line.

FIG. 21 is a schematic graph showing the unevenness of the front surface of the rubber sheet at a cross-section taken along a fifth straight line.

FIG. 22 is a schematic graph showing one end position and the other end position of the rubber sheet, the width of the rubber sheet, and the center position of the rubber sheet.

FIG. 23 is a diagram for explaining a principle for measuring the thickness of a rubber sheet in a modification.

### DESCRIPTION OF EMBODIMENTS

An embodiment of the present invention will be described in detail with reference to the accompanying drawings. Elements denoted by the same reference numeral throughout the drawings have the same configuration and, thus, repeated descriptions of the same configuration will be omitted. In the present specification, elements are denoted by a reference numeral without an additional hyphenated number when referred to generally (e.g. a first light source 10) and are denoted by a reference numeral with an additional hyphenated number when referred to specifically (e.g. a first light source 10-1).

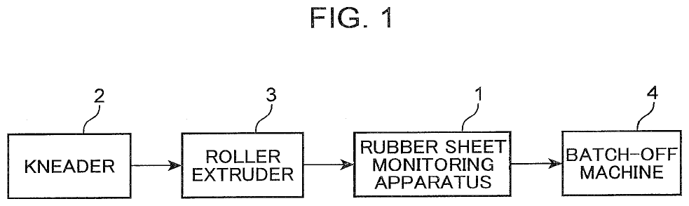

FIG. 1 is a diagram for explaining a process in which a rubber sheet monitoring apparatus according to the embodiment is applied, the process beginning with a kneading step and ending with a rubber sheet cutting step. A kneader 2 kneads various compounding raw rubber and agents including silica to form a mass of rubber mixture and sends it to a roller extruder 3. The roller extruder 3 extrudes the mass of rubber mixture and rolls it using a rolling roller. Consequently, the rubber mixture is formed into a rubber sheet and fed from the roller extruder 3. The rubber sheet contains silica.

The rubber sheet monitoring apparatus 1 measures the thickness and other properties of the rubber sheet fed from the roller extruder 3. A batch-off machine 4 cuts the rubber sheet, whose thickness and other properties have been measured by the rubber sheet monitoring apparatus 1, into pieces having a predetermined length, and stacks cut pieces of the rubber sheet.

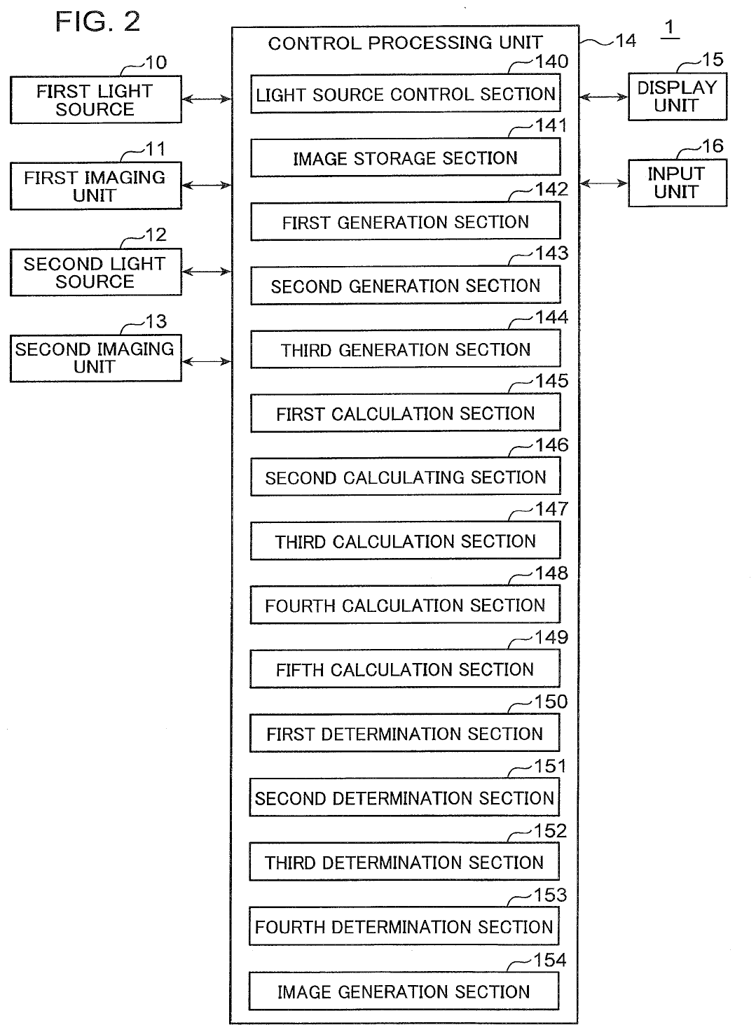

FIG. 2 is a block diagram showing a configuration of the rubber sheet monitoring apparatus 1 according to the embodiment. The rubber sheet monitoring apparatus 1 includes a first light source 10, a first imaging unit 11, a second light source 12, a second imaging unit 13, a control processing unit 14, a display unit 15, and an input unit 16. The rubber sheet monitoring apparatus 1 calculates data representing the height of a cross-sectional edge (the shape of a front surface and the shape of a back surface) of the rubber sheet using a light-section method, and calculates the thickness and other properties of the rubber sheet using the data.

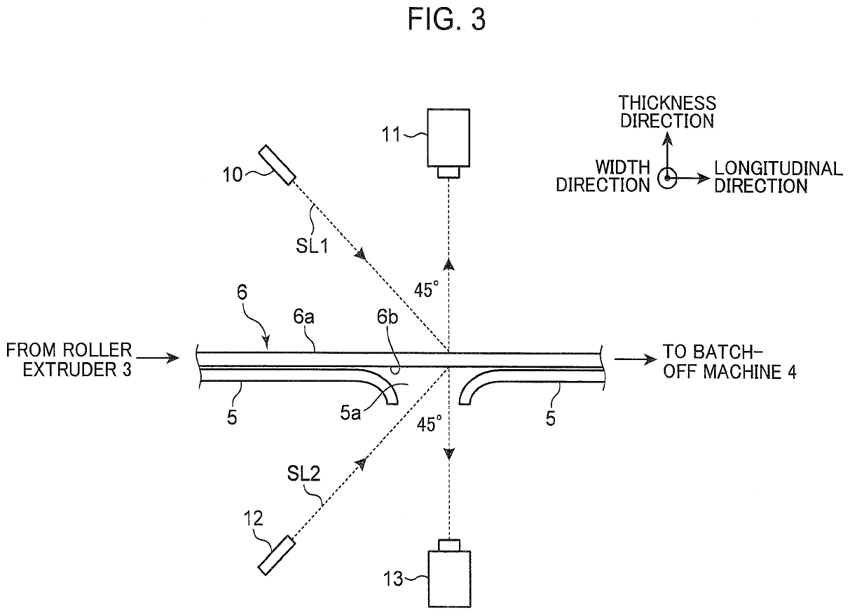

FIG. 3 is a schematic view showing a first example arrangement of the first light source 10, the first imaging unit 11, the second light source 12, and the second imaging unit 13. A rubber sheet 6 fed from the roller extruder 3 is supported on a support plate 5 and conveyed to the batch-off machine 4. The rubber sheet 6, on the way to the batch-offmachine 4, passes through a space surrounded by the first light source 10, the first imaging unit 11, the second light source 12, and the second imaging unit 13. The support plate 5 includes two separate parts divided with a gap 5a defined therebetween in the space. The rubber sheet 6 has a front surface 6a and a back surface 6b, the back surface 6b being defined by a surface in contact with the support plate 5. “One surface of the rubber sheet 6” referred to hereinafter means one of the front surface 6a and the back surface 6b, and “the other surface of the rubber sheet 6” referred to hereinafter means the other of the front surface 6a and the back surface 6b.

The first light source 10 and the first imaging unit 11 are disposed above the front surface 6a of the rubber sheet 6. The first light source 10 is a laser light source for emitting a first sheet beam SL1. Being a sheet beam, tip of the first sheet beam SL1 is shaped into a straight line. The first light source 10 is so disposed that the straight line extends in the width direction of the rubber sheet 6. The optical axis of the first imaging unit 11 is set in a direction perpendicular to the front surface 6a of the rubber sheet 6. The first sheet beam SL is irradiated on the front surface 6a of the rubber sheet 6 at an angle of, for example, 45 degrees with respect the optical axis of the first imaging unit 11. The first imaging unit 11 is, for example, a camera capable of recording video which includes a CCD image sensor or a CMOS image sensor.

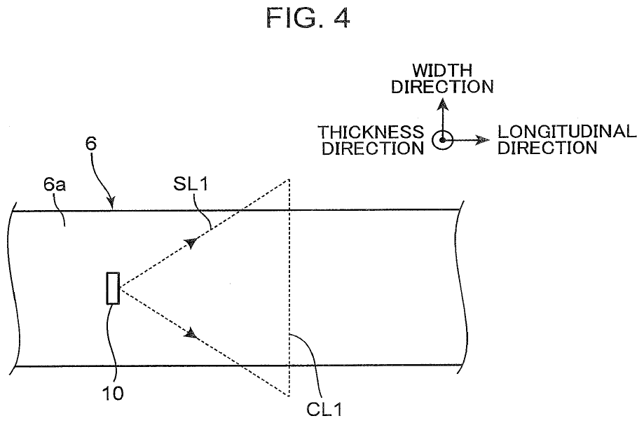

The first sheet beam SL1 irradiated on the front surface 6a of the rubber sheet 6 forms a first optical cutting edge CL1 extending in the width direction of the rubber sheet 6 as shown in FIG. 4. FIG. 4 is a plan view of the rubber sheet 6 having the front surface 6a on which the first optical cutting edge CL1 is formed by the first sheet beam SL1 being irradiated thereon. The first imaging unit 11 captures images of the first optical cutting edge CL1 at a predetermined frame rate. The predetermined frame rate is the frequency at which images of the first optical cutting edge CL1 continuously formed on the front surface 6a of the rubber sheet 6 being fed are captured, and is determined based on the feeding speed of the rubber sheet 6. In this manner, the first imaging unit 11 functions as a first acquisition unit. The first acquisition unit successively acquires images of the first optical cutting edge CL1 formed on one surface of the rubber sheet 6 being fed, synchronously with the feeding speed of the rubber sheet 6. The successive acquisition of images of the first optical cutting edge CL1 synchronous with the feeding speed allows identification of correspondence between an image of the first optical cutting edge CL1 and a position in the longitudinal direction of the rubber sheet 6.

With reference to FIG. 3, the second light source 12 and the second imaging unit 13 are disposed under the back surface 6b of the rubber sheet 6. The second light source 12 is a laser light source for emitting a second sheet beam SL2. Being a sheet beam, tip of the second sheet beam SL2 is shaped into a straight line. The second light source 12 is so disposed that the straight line extends in the width direction of the rubber sheet 6. The optical axis of the second imaging unit 13 is set in a direction perpendicular to the back surface 6b of the rubber sheet 6. The position of the optical axis of the second imaging unit 13 coincides with the position of the optical axis of the first imaging unit 11. The second sheet beam SL2 is irradiated on the back surface 6b of the rubber sheet 6 at an angle of, for example, 45 degrees with respect to the optical axis of the second imaging unit 13. The second imaging unit 13 is, similarly to the first imaging unit 11, a camera capable of recording video.

The rubber sheet monitoring apparatus 1 may be configured without the first imaging unit 11 and the second imaging unit 13. In such a configuration, the first acquisition unit is configured in the form of a first input unit (input interface circuit) to which images of the first optical cutting edge CL1 successively captured by the first imaging unit 11 are successively input, and the second acquisition unit is configured in the form of a second input unit (input interface circuit) to which images of the second optical cutting edge CL2 successively captured by the second imaging unit 13 are successively input.

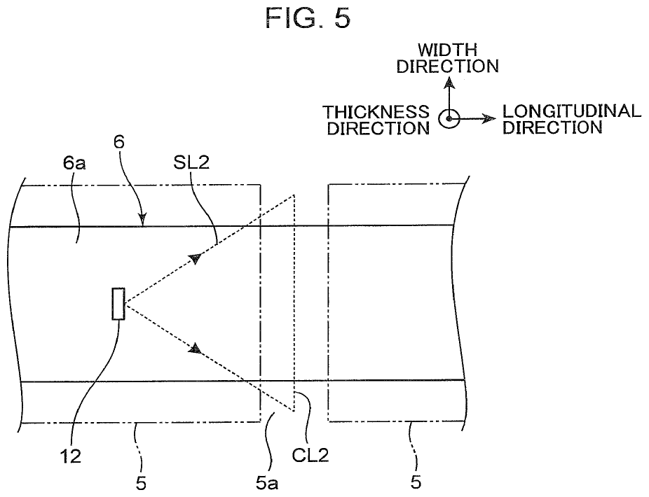

The second sheet beam SL2 emitted from the second light source 12 is irradiated on the back surface 6b of the rubber sheet 6 through the gap 5a. Consequently, a second optical cutting edge CL2 extending in the width direction of the rubber sheet 6 is formed on the back surface 6b of the rubber sheet 6 as shown in FIG. 5. FIG. 5 is a plan view of the rubber sheet 6 having the back surface 6b on which the second optical cutting edge CL2 is formed by the second sheet beam SL2 being irradiated thereon. The second imaging unit 13 captures images of the second optical cutting edge CL2 through the gap 5a. The frame rate of the second imaging unit 13 is the same as that of the first imaging unit 11. The second imaging unit 13 functions as a second acquisition unit. The second acquisition unit successively acquires images of the second optical cutting edge CL2 formed on the other surface of the rubber sheet 6 being fed, synchronously with the feeding speed of the rubber sheet 6. The successive acquisition of images of the second optical cutting edge CL2 synchronous with the feeding speed allows identification of correspondence between an image of the second optical cutting edge CL2 and a position in the longitudinal direction of the rubber sheet 6.

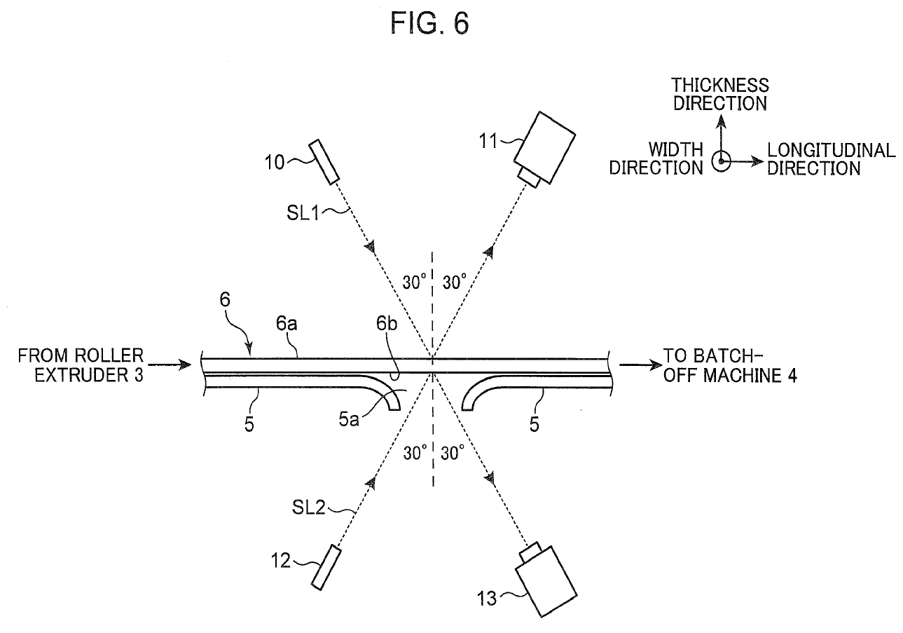

Light-section methods include a type (diffuse reflection type) in which an imaging unit (camera) receives diffusely reflected component of a sheet beam and a type (specular reflection type) in which an imaging unit (camera) receives specularly reflected component of a sheet beam. The specular reflection type is applicable when the front surface 6a and the back surface 6b of the rubber sheet 6 has mirror-like properties, and the diffuse reflection type is applicable to other cases. FIG. 3 shows a case using the diffuse reflection type. The specular reflection type will be described with reference to FIG. 6. FIG. 6 is a schematic view showing a second example arrangement of the first light source 10, the first imaging unit 11, the second light source 12, and the second imaging unit 13. FIG. 6 differs from FIG. 3 in the angle of the first sheet beam SL1, the angle of the optical axis of the first imaging unit 11, the angle of the second sheet beam SL2, and the angle of the optical axis of the second imaging unit 13. In FIG. 6, the first light source 10 and the first imaging unit 11 are disposed at an angle allowing the first imaging unit 11 to receive specularly reflected light, and the second light source 12 and the second imaging unit 13 are disposed at an angle allowing the second imaging unit 13 to receive specularly reflected light.

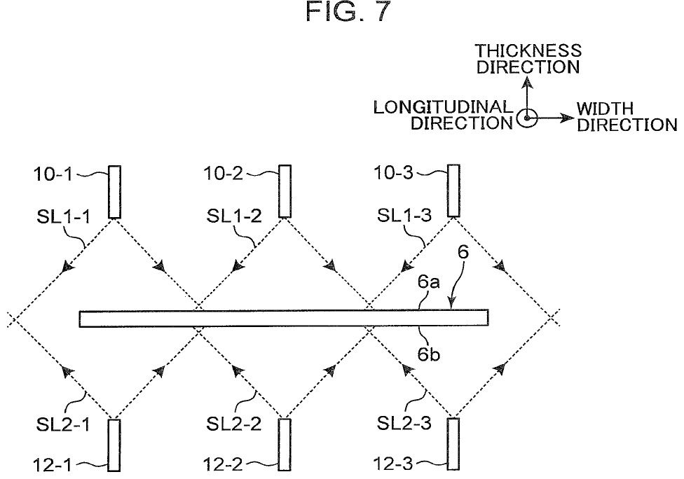

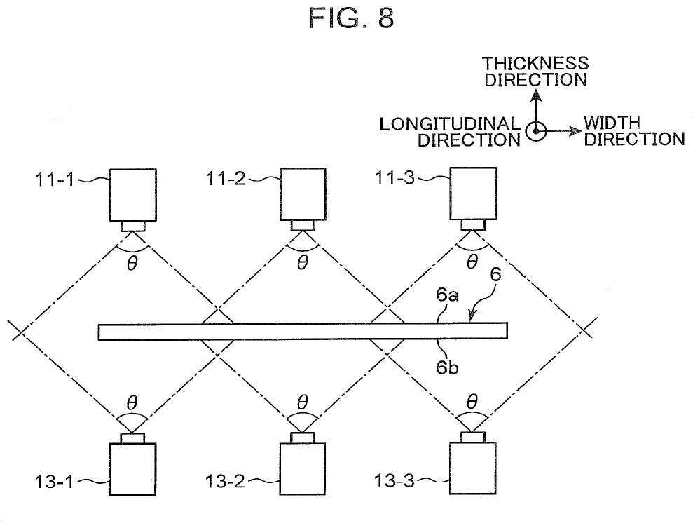

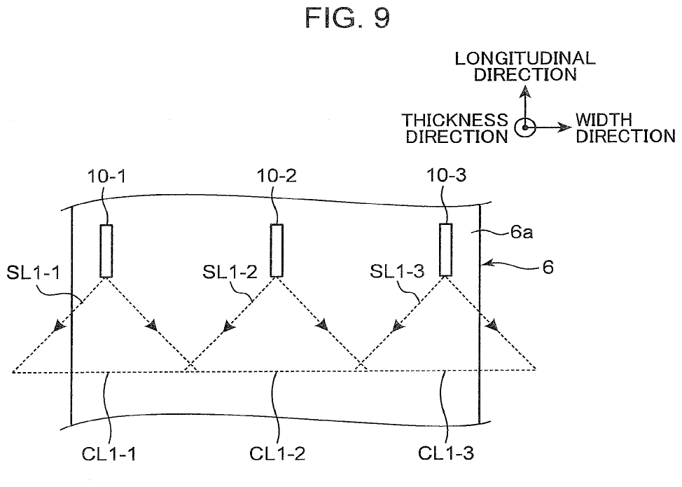

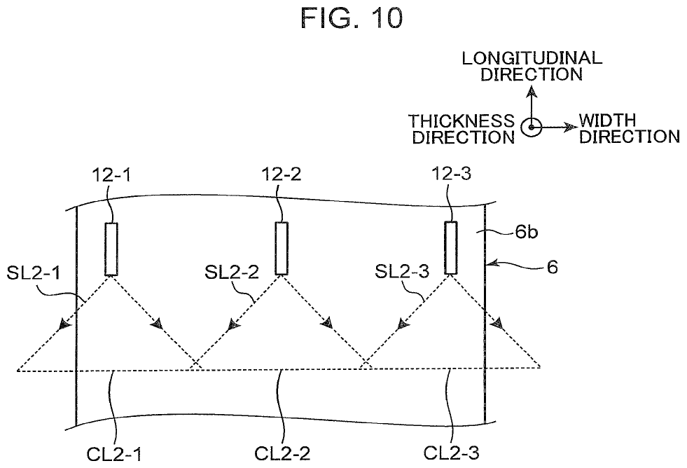

When the rubber sheet 6 is wide, a plurality of first light sources 10 and first imaging units 11 and a plurality of second light sources 12 and second imaging units 13 are disposed. For example, each plurality includes three components, as described below. FIG. 7 is a schematic view showing arrangement of three first light sources 10-1 to 10-3 and three second light sources 12-1 to 12-3. FIG. 8 is a schematic view showing arrangement of three first imaging units 11-1 to 11-3 and three second imaging units 13-1 to 13-3. FIG. 9 is a plan view of the front surface 6a of the rubber sheet 6 on which first optical cutting edges CL1-1 to 1-3 are formed by first sheet beams SL1-1 to SL1-3 respectively emitted from the three first light sources 10-1 to 10-3. FIG. 10 is a plan view of the back surface 6b of the rubber sheet 6 on which second optical cutting edges CL2-1 to 2-3 are formed by second sheet beams SL2-1 to SL2-3 respectively emitted from the three second light sources 12-1 to 12-3.

With reference to FIGS. 7 and 9, the three first light sources 10-1, 10-2, and 10-3 are disposed above the front surface 6a of the rubber sheet 6 at a predetermined distance from one another in the width direction of the rubber sheet 6. The first sheet beam SL1-1 emitted from the first light source 10-1 forms the first optical cutting edge CL1-1 at and near one end of the rubber sheet 6. The first sheet beam SL1-2 emitted from the first light source 10-2 forms the first optical cutting edge CL1-2 at and near the center of the rubber sheet 6. The first sheet beam SL1-3 emitted from the first light source 10-3 forms the first optical cutting edge CL1-3 at and near the other end of the rubber sheet 6. In the example described here, one end of the rubber sheet 6 is a left end and the other end is a right end.

One end of the first optical cutting edge CL1-1 closer to the center of the rubber sheet 6 overlaps one end of the first optical cutting edge CL1-2 closer to one end of the rubber sheet 6. The other end of the first optical cutting edge CL1-2 closer to the other end of the rubber sheet 6 overlaps one end of the first optical cutting edge CL1-3 closer to the center of the rubber sheet 6. Thus, the first optical cutting edges CL1-1 to CL1-3 cover the entire width of the rubber sheet 6.

With reference to FIGS. 7 and 10, the three second light sources 12-1, 12-2, and 12-3 are disposed under the back surface 6b of the rubber sheet 6 at a predetermined distance from one another in the width direction of the rubber sheet 6. The second sheet beam SL2-1 emitted from the second light source 12-1 forms the second optical cutting edge CL2-1 at and near one end of the rubber sheet 6. The second sheet beam SL2-2 emitted from the second light source 12-2 forms the second optical cutting edge CL2-2 at and near the center of the rubber sheet 6. The second sheet beam SL2-3 emitted from the second light source 12-3 forms the second optical cutting edge CL2-3 at and near the other end of the rubber sheet 6.

One end of the second optical cutting edge CL2-1 closer to the center of the rubber sheet 6 overlaps one end of the second optical cutting edge CL2-2 closer to one end of the rubber sheet 6. The other end of the second optical cutting edge CL2-2 closer to the other end of the rubber sheet 6 overlaps one end of the first optical cutting edge CL2-3 closer to the center of the rubber sheet 6. Thus, the second optical cutting edges CL2-1 to CL2-3 cover the entire width of the rubber sheet 6.

With reference to FIGS. 8 and 9, the angle of view θ of the first imaging unit 11-1 is within a range enabling imaging of the entire first optical cutting edge CL1-1. The angle of view θ of the first imaging unit 11-2 is within a range enabling imaging of the entire first optical cutting edge CL1-2. The angle of view θ of the first imaging unit 11-3 is within a range enabling imaging of the entire first optical cutting edge CL1-3.

With reference to FIGS. 8 and 10, the angle of view θ of the second imaging unit 13-1 is within a range enabling imaging of the entire second optical cutting edge CL2-1. The angle of view θ of the second imaging unit 13-2 is within a range enabling imaging of the entire second optical cutting edge CL2-2. The angle of view θ of the second imaging unit 13-3 is within a range enabling imaging of the entire second optical cutting edge CL2-3.

Since the first optical cutting edge CL1 and the second optical cutting edge CL2 are used to measure the width of the rubber sheet 6, they need to have a length greater than or equal to the width of the rubber sheet 6. In the case where a single first light source 10 is used, the first light source 10 needs to be further away from the rubber sheet 6 as the rubber sheet 6 becomes wider, in order to form a first optical cutting edge CL1 having a length greater than or equal to the width of the rubber sheet 6. The same can be said for the second light source 12. To realize such a configuration, the first light source 10 and the second light source 12 will need to have a greater output, which may cause the first sheet beam SL1 and the second sheet beam SL2 to be classified as Safety Class 3 or higher.

According to the configuration described with reference to FIGS. 7 to 10, the plurality of first light sources 10 are disposed at a predetermined distance from one another in the width direction of the rubber sheet 6. Therefore, the first light sources 10 do not need to be brought further away from the rubber sheet 6, and thus the first light sources 10 can maintain a low output (allowing the sheet beams to be classified as Safety Class 1 or 2). The same can be said for the second light sources 12.

In the case where a single first imaging unit 11 and a single second imaging unit 13 are used, the first imaging unit 11 will need to be further away from the rubber sheet 6 as the rubber sheet 6 becomes wider, in order to image the first optical cutting edge CL1 having a length greater than or equal to the width of the rubber sheet 6, and the second imaging unit 13 will correspondingly need to be further away from the rubber sheet 6 in order to image the second optical cutting edge CL2 having a length greater than or equal to the width of the rubber sheet 6. This will result in lower resolution of the images of the first optical cutting edge CL1 and the second optical cutting edge CL2. In particular, degradation of resolution at one end and the other end of the rubber sheet 6 will make it difficult to measure the width of the rubber sheet 6 at a high accuracy. According to the configuration described with reference to FIGS. 7 to 10, the first imaging unit 10-1 is assigned to image one end of the rubber sheet 6, which makes it possible to image one end of the rubber sheet 6 without increasing the distance between the rubber sheet 6 and the first imaging unit 10-1. The first imaging unit 10-3 is assigned to image the other end of the rubber sheet 6, which makes it possible to image the other end of the rubber sheet 6 without increasing the distance between the rubber sheet 6 and the first imaging unit 10-3. Therefore, this configuration allows the images of one end and the other end of the rubber sheet 6 to have a high resolution even when the rubber sheet 6 is wide. The same can be said for the second imaging units 13.

As seen from the above, the configuration described with reference to FIGS. 7 and 10 is suitable when the rubber sheet 6 is wide (for example, 1000 mm to 1500 mm).

With reference to FIG. 2, the control processing unit 14 controls the first light source 10, the first imaging unit 11, the second light source 12, and the second imaging unit 13, and calculates the thickness and other characteristics of the rubber sheet 6. The control processing unit 14 includes, as functional blocks, a light source control section 140, an image storage section 141, a first generation section 142, a second generation section 143, a third generation section 144, a first calculation section 145, a second calculation section 146, a third calculation section 147, a fourth calculation section 148, a fifth calculation section 149, a first determination section 150, a second determination section 151, a third determination section 152, a fourth determination section 153, and an image generation section 154. The control processing unit 14 is realized by means of hardware such as a CPU (Central Processing Unit), a RAM (Random Access Memory), a ROM (Read Only Memory), and an HDD (Hard Disk Drive), and programs and data for performing the functions of the above-mentioned function blocks. In other words, the control processing unit 14 can be realized by a hardware processor (such as a CPU).

The light source control section 140 turns on and off the first light source 10 and the second light source 12 and controls the magnitude of their outputs.

The first imaging unit 11 captures images of the first optical cutting edge CL1 at the predetermined frame rate and transmits the images (each frame) to the control processing unit 14. Similarly, the second imaging unit 13 captures images of the second optical cutting edge CL2 at the same frame rate as the first imaging unit 11 and transmits the images (each frame) to the control processing unit 14. The control processing unit 14 causes the image storage section 141 to store the received images (frame) of the first optical cutting edge CL1 and images (frame) of the second optical cutting edge CL2. In this manner, the image storage section 141 successively stores images of the first optical cutting edge CL1 successively acquired by the first acquisition unit (the first imaging unit 11) and images of the second optical cutting edge CL2 successively acquired by the second acquisition unit (the second imaging unit 13).

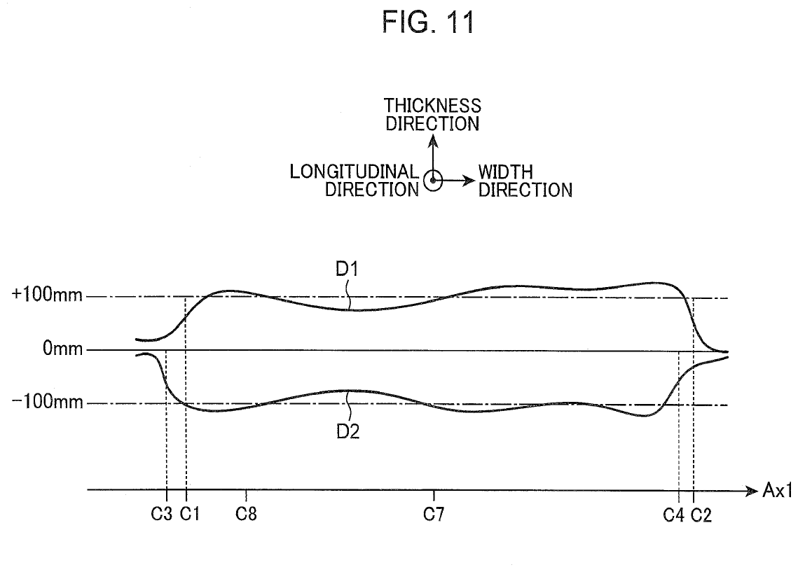

The first generation section 142 successively reads the images (frames) of the first optical cutting edge CL1 successively stored in the image storage section 141 and generates first data D1, and successively reads the images (frames) of the second optical cutting edge CL1 successively stored in the image storage section 141 and generates second data D2. FIG. 11 is a diagram for explaining an example of the first data D1 and the second data D2. The coordinate axis Ax1 points in the width direction of the rubber sheet 6 (FIG. 3). Each first data D1 is generated using an image of the first optical cutting edge CL1 and represents the height variation of a widthwise cross-sectional edge of the rubber sheet 6. Each second data D2 is generated using an image of the second optical cutting edge CL2 and represents the height variation of a widthwise cross-sectional edge of the rubber sheet 6. The first image data D1 and the second image data D2 are generated by a known image processing method used in light section methods. The same applies to third data to sixth data described later.

The cross-sectional edge represented by the first data D1 is an edge defined on the front surface side of a cross-section of the rubber sheet 6. The first data D1 represents the height variation of a cross-sectional edge defined on the front surface 6a of the rubber sheet 6. The first data D1 allows detection of a height of the front surface 6a (FIG. 3) of the rubber sheet 6. The cross-sectional edge represented by the second data D2 is an edge defined on the back surface side of a cross-section of the rubber sheet 6. The second data D2 represents the height variation of a cross-sectional edge defined on the back surface 6b of the rubber sheet 6. The second data D2 allows detection of a height of the back surface 6a (FIG. 3) of the rubber sheet 6. The first data D1 and the second data D2 shown in FIG. 11 are data concerning the same cross-section (in other words, the cross-sectional edge represented by the first data D1 and the cross-sectional edge represented by the second data D2 are on the same longitudinal coordinate of the rubber sheet 6).

As described above, the first generation section 142 generate first data D1 for each of the images of the first optical cutting edge CL1 successively acquired by the first acquisition unit (the first imaging unit 11) and generates second data D2 for each of the images of the second optical cutting edge CL2 successively acquired by the second acquisition unit (the second imaging unit 13).

The first calculation section 145 calculates, using the first data D1, the evaluation value for unevenness of the surface 6a of the rubber sheet 6. Specifically, regarding a cross-sectional edge of the rubber sheet 6 corresponding to first data D1, the first calculation section 145 calculates, using the first data, the average height and the height standard deviation of the cross-sectional edge, and acquires the calculated average height and height standard deviation as the unevenness evaluation value of the front surface 6a of the rubber sheet 6. The first calculation section 145 calculates, in real time, the unevenness evaluation value of the front surface 6a of the rubber sheet 6 being fed from the roller extruder 3 to the rubber sheet monitoring apparatus 1.

The first determination section 150 determines in real time whether the unevenness evaluation value of the front surface 6a of the rubber sheet 6 calculated in real time by the first calculation section 145 is within a predetermined first desired range. When the first determination section 150 determines that the calculated unevenness evaluation value of the front surface 6a of the rubber sheet 6 is outside the first desired range, the control processing unit 14 notifies a user of the determination result. Such notification may be an audible notification (such as an alarm) or a visual notification (such as a revolving light). The same can be said for the notification described below.

The first calculation section 145 calculates the unevenness evaluation value over the entirety of the front surface 6a of the rubber sheet 6. The first determination section 150 determines whether each calculated unevenness evaluation value is within the first desired range. Therefore, the rubber sheet monitoring apparatus 1 according to the embodiment makes it possible to evaluate the front surface 6a of the rubber sheet 6 (enables good/bad evaluation of the front surface 6a of the rubber sheet 6).

Although the description provided above relates to the front surface 6a of the rubber sheet 6, the back surface 6b of the rubber sheet 6 can be similarly described with use of the second data D2.

The second calculation section 146 calculates, using first data D1 and second data D2 for the same cross-section, the thickness of the rubber sheet 6 at the cross-section. With reference to FIG. 11, for a metal plate having a thickness of 200 mm, for example, the user uses the rubber sheet monitoring apparatus 1 to calculate data (corresponding to the first data D1) representing the height of the cross-sectional edge defined on the front surface side of a cross-section of the metal plate, and data (corresponding to the second data D2) representing the height of the cross-sectional edge defined on the back surface side of the cross-section of the metal plate. The former data is on the line indicated by “+100 mm” in FIG. 11 and the latter data is on the line indicated by “−100 mm” in FIG. 11. The first data D1 is calculated based on the line indicated by “+100 mm” and the second data D2 is calculated based on the line indicated by “−100 mm”. Data obtained by subtracting the second data D2 from the first data D1 represents the thickness of the cross-section. In this manner, the second calculation section 146 calculates the difference between first data D and second data D2 for the same cross-section and acquires it as the thickness of the rubber sheet 6. The second calculation section 146 calculates in real time the cross-sectional thickness of the rubber sheet 6 being fed from the roller extruder 3 to the rubber sheet monitoring apparatus 1.

The second calculation section 146 calculates, using first data D1 and second data D2 for the same cross-section (in other words, using first data D1 and second data D2 on the same longitudinal coordinate of the rubber sheet 6), the thickness of the rubber sheet 6 at the cross-section. The second calculation section 146 performs such calculation using each first data D1 generated using the successively acquired images of the first optical cutting edge CL1 and each second data D2 generated using the successively acquired images of the second optical cutting edge CL2. Therefore, the rubber sheet monitoring apparatus 1 according to the embodiment makes it possible to calculate the thickness of the rubber sheet 6 containing silica, over its entire surface.

The second determination section 151 determines in real time whether the thickness of the rubber sheet 6 calculated in real time by the first calculation section 145 is within a predetermined second desired range. When the second determination section 150 determines that the calculated thickness of the rubber sheet 6 is outside the second desired range, the control processing unit 14 notifies the user of the determination result.

As described above, the second calculation section 146 calculates the thickness of the rubber sheet 6 over the entire surface of the rubber sheet 6. The second determination section 146 determines whether each calculated thickness is within the second desired range. Therefore, the rubber sheet monitoring apparatus 1 according to the embodiment makes it possible to evaluate the thickness of the rubber sheet 6 (enables good/bad evaluation of the thickness of the rubber sheet 6).

With reference to FIG. 11, the third calculation section 147 calculates, using first data D1 for a cross-section, a first coordinate C1 indicating a position of one end of the rubber sheet 6 in the width direction and a second coordinate C2 indicating a position of the other end of the rubber sheet 6, and calculates, using second data for the same cross-section, a third coordinate C3 indicating a position of one end of the rubber sheet 6 in the width direction and a fourth coordinate C4 indicating a position of the other end of the rubber sheet 6. The first to fourth coordinates are one-dimensional coordinates with the coordinate axis Ax1 pointing in the width direction of the rubber sheet 6. The third calculation section 147 calculates, in real time, the first to fourth coordinates C1 to C4 of the rubber sheet 6 being fed from the roller extruder 3 to the rubber sheet monitoring apparatus 1.

The third calculation section 147 calculates the coordinates of one end and the other end of the rubber sheet 6, for example, in the following manner. Handling the first data D1 and the second data D2 as absolute values, the third calculation section 147 finds two coordinates where the value of the first data D1 becomes less than a predetermined value and identifies them as coordinates of one end and the other end of the rubber sheet 6, and finds two coordinates where the value of the second data D2 becomes less than the predetermined value and identifies them as coordinates of one end and the other end of the rubber sheet 6.

The third calculation section 147 calculates, as the width of the rubber sheet 6, the distance between one of the first coordinate C1 and the third coordinate C3 closer to the center of the rubber sheet 6 and one of the second coordinate C2 and the fourth coordinate C4 closer to the center of the rubber sheet 6. In the case of FIG. 11, the distance between the first coordinate C1 and the fourth coordinate C4 is calculated as the width of the rubber sheet 6. The third calculation section 147 calculates in real time the width of the rubber sheet 6 being fed from the roller extruder 3 to the rubber sheet monitoring apparatus 1.

On the same cross-section, the first coordinate C1 and the third coordinate C3 are expected to coincide with each other, but they sometimes do not coincide, for example, due to noise. Similarly, the second coordinate C2 and the fourth coordinate C4 are expected to coincide with each other, but they sometimes do not coincide, for example, due to noise. The third calculation section 147 calculates, as the width of the rubber sheet 6, the distance between one of the first coordinate C1 and the third coordinate C3 closer to the center of the rubber sheet 6 and one of the second coordinate C2 and the fourth coordinate C4 closer to the center of the rubber sheet 6. This makes it possible to determine that the rubber sheet 6 has a width at least equal to the calculated value.

The third determination section 152 determines in real time whether the width of the rubber sheet 6 calculated in real time by the third calculation section 147 is within a predetermined third desired range. When the third determination section 152 has determined that the calculated width of the rubber sheet is outside the third desired range, the control processing unit 14 notifies the user of the determination result.

The third calculation section 147 may calculate the width of the rubber sheet 6 using the first data D1 and without using the second data D2. Specifically, the third calculation section 147 extracts from first data D1 a range of heights less than the above-mentioned average height calculated by the first calculation section 145 and less than or equal to a predetermined second threshold value (the range needs to exceed a predetermined value because if it is short, it will not represent an end of the rubber sheet 6. For example, the third calculation section 147 extracts a range of values on the left side of the coordinate C1 and a range of values on the right side of the coordinate C2 in FIG. 11.). The third calculation section 147 then identifies from the extracted range coordinates of widthwise opposite ends of the rubber sheet 6 (for example, the coordinates C1 and C2) and calculates the distance between the identified coordinates of the opposite ends. The third calculation section 147 then calculates the distance on the rubber sheet 6 corresponding to the calculated distance between the coordinates and acquires it as the width of the rubber sheet 6. A rubber sheet monitoring apparatus 1 according to a modification described later calculates the width of the rubber sheet 6 using this method.

The second generation section 143 collects from pieces of first data D1 successively generated by the first generation section 142 values at the same coordinate in the with direction of the rubber sheet 6, and generates third data D3 representing the height of a first cross-sectional edge extending in the longitudinal direction of the rubber sheet 6. For example, with reference to FIG. 11, the second generation section 143 collects values of pieces of first data D1 at a coordinate C7 and generates third data D3 representing the height of the first cross-sectional edge at the coordinate C7. Similarly, the second generation section 143 generates fourth data D4 representing the height of a second cross-sectional edge extending in the longitudinal direction of the rubber sheet 6 at a different coordinate in the width direction of the rubber sheet 6 from the first cross-sectional edge. For example, the second generation section 143 collects values of pieces of first data D1 at a coordinate C8 and generates fourth data D4 representing the height of the second cross-sectional edge at the coordinate C8.

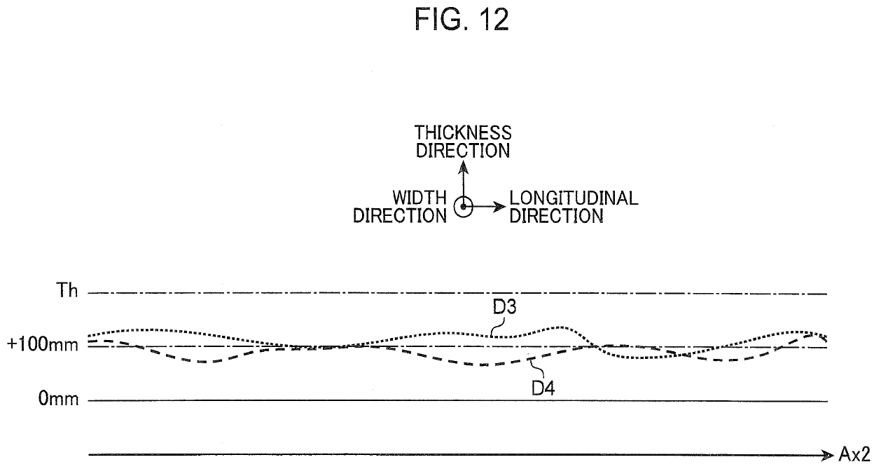

FIG. 12 is a diagram for explaining an example of the third data D3 and the fourth data D4. The coordinate axis Ax2 points in the longitudinal direction of the rubber sheet 6. The line denoted by “+100 mm” is used in the same manner as described above. In this manner, the second generation section 143 generates, using images of the first optical cutting edge CL1 successively acquired by the first acquisition unit (the first imaging unit 11), the third data D3 representing the height of the first cross-sectional edge extending in the longitudinal direction of the rubber sheet 6 and the fourth data D4 representing the height of the second cross-sectional edge extending in the longitudinal direction of the rubber sheet 6 at a different coordinate in the width direction of the rubber sheet 6 from the first cross-sectional edge.

When the rubber sheet 6 is fed from the roller extruder 3 at a high speed, the rubber sheet 6 is likely to bend (warp). The speed is, for example, 1.6 to 67 meters per minute. It may happen that the heights of the first cross-sectional edge and the second cross-sectional edge extending in the longitudinal direction of the rubber sheet 6 both exceed a predetermined threshold value Th at the same longitudinal coordinate of the rubber sheet 6. The present inventors have considered that the reason why the rubber sheet 6 is bent (warped) is a high feeding speed of the rubber sheet 6. The fourth determination section 153 determines, when the heights of the first cross-sectional edge and the second cross-sectional edge both exceed the threshold value Th at the same longitudinal coordinate of the rubber sheet 6, that the rubber sheet 6 is bent (warped). The fourth determination section 153 determines in real time, for the rubber sheet 6 being fed from the roller extruder 3 to the rubber sheet monitoring apparatus 1, whether the heights of the first cross-sectional edge and the second cross-sectional edge both exceed the threshold value Th. When the fourth determination section 153 has determined that the heights of the first cross-sectional edge and the second cross-sectional edge both exceed the threshold value Th, the control processing unit 14 notifies the user.

Although in the described embodiment, the third data D3 and the fourth data D4 are generated using images of the first optical cutting edge CL1, these data may be generated using images of the second optical cutting edge CL2.

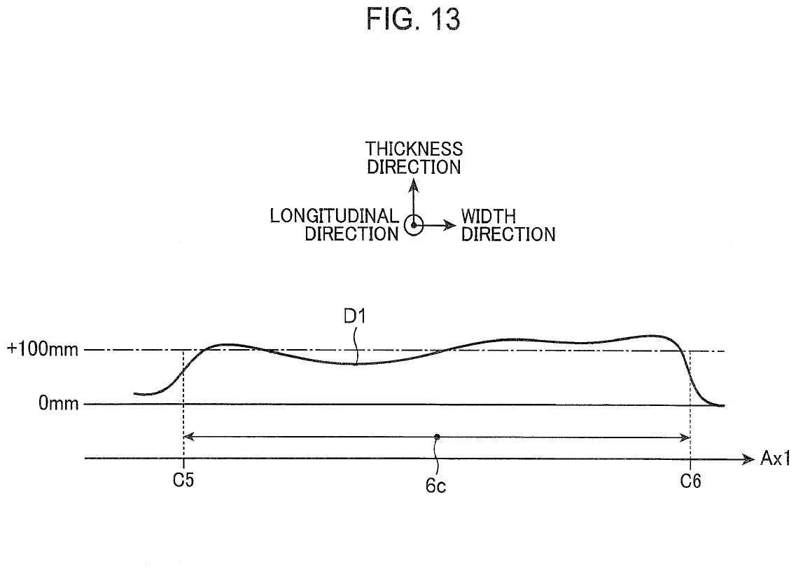

The fourth calculation section 148 calculates the central position of the rubber sheet 6 using the first data D1. FIG. 13 is a diagram for explaining an example of the first data D1. The line denoted by “+100 mm” and the coordinate axis Ax1 are used in the same manner as described above. The center 6c of the rubber sheet 6 is a widthwise center of the rubber sheet 6. The fourth calculation section 148 calculates, using the first data D1, a fifth coordinate C5 (one coordinate) indicating the position of one end of the rubber sheet 6 in the width direction and a sixth coordinate C6 (the other coordinate) indicating the position of the other end of the rubber sheet 6. For example, the fourth calculation section 148 finds two coordinates where the value of the first data D1 becomes less than a predetermined value and identifies them as the coordinates of one end and the other end of the rubber sheet 6 in the width direction.

The fourth calculation section 148 calculates the middle coordinate between the fifth coordinate C5 and the sixth coordinate C6 as the center 6c of the rubber sheet 6. The fourth calculation section 148 calculates in real time, for the rubber sheet 6 being fed from the roller extruder 3 to the rubber sheet monitoring apparatus 1, the center 6c of the rubber sheet 6. Therefore, the control processing unit 14 can determine in real time, by monitoring the value of the center 6c, whether the rubber sheet 6 is fed in a meandering manner. For example, when a change in the value of the center 6c of the rubber sheet 6 exceeds a predetermined threshold value, the control processing unit 14 determines that the rubber sheet 6 is fed in a meandering manner. The control processing unit 14, when having determined that the rubber sheet 6 is fed in a meandering manner, notifies the user.

Although in the described embodiment, the fifth coordinate C5 and the sixth coordinate C6 are calculated using the first data D1, they may be calculated using the second data D2.

As described above, the image storage section 141 successively stores images of the first optical cutting edge CL1 successively acquired by the first acquisition unit (the first imaging unit 11) and images of the second optical cutting edge CL2 successively acquired by the second acquisition unit (the second imaging unit 13). Thus, the image storage section 141 accumulates images of the first optical cutting edge CL1 and the second optical cutting edge CL2 over the entire surface of the rubber sheet 6. Therefore, using accumulated images of the first optical cutting edge CL1 makes it possible to obtain fifth data representing the height of a predetermined third cross-sectional edge of the rubber sheet 6. For example, it is possible to obtain data (fifth data) representing the height of a predetermined third cross-sectional edge extending in the width direction of the rubber sheet 6 and the height of a predetermined third cross-sectional edge extending in the longitudinal direction of the rubber sheet 6. Similarly, using accumulated images of the second optical cutting edge CL2 makes it possible to obtain sixth data representing the height of a predetermined fourth cross-sectional edge of the rubber sheet 6. For example, it is possible to obtain data (sixth data) representing the height of a predetermined fourth cross-sectional edge extending in the width direction of the rubber sheet 6 and the height of a predetermined fourth cross-sectional edge extending in the longitudinal direction of the rubber sheet 6. The third cross-sectional edge and the fourth cross-sectional edge may be on the same cross-section or different cross-sections.

The third generation section 144 generates, using images of the first optical cutting edge CL1 successively acquired by the first acquisition unit (the first imaging unit 11), fifth data (not shown) representing the height variation of a predetermined third cross-sectional edge of the rubber sheet 6 and generates, using images of the second optical cutting edge CL2 successively acquired by the second acquisition unit (the second imaging unit 13), sixth data (not shown) representing the height variation of a predetermined fourth cross-sectional edge of the rubber sheet 6. In the case of a widthwise cross-sectional edge of the rubber sheet 6, the fifth data represents a height of the front surface 6a of the rubber sheet 6 similarly to the first data D1 shown in FIG. 11 and the sixth data represents a height of the back surface 6b of the rubber sheet 6 similarly to the second data D2 shown in FIG. 11. In the case of a longitudinal cross-sectional edge of the rubber sheet 6, the fifth data represents a height of the front surface 6a of the rubber sheet 6 similarly to the third data D3 shown in FIG. 12 and the sixth data represents a height of the back surface 6b of the rubber sheet 6 similarly to the fourth data D4 shown in FIG. 12.

The fifth calculation section 149 calculates, using the fifth data, the average height and the height standard deviation of the third cross-sectional edge, and calculates, using the sixth data, the average height and the height standard deviation of the fourth cross-sectional edge.

The third cross-sectional edge, generated using images of the first optical cutting edge CL1, is the cross-sectional edge defined on the front surface side of a predetermined cross-section of the rubber sheet 6. Therefore, the average height and the height standard deviation of the third cross-sectional edge can be regarded as the unevenness evaluation value of the front surface 6a of the rubber sheet 6. The fourth cross-sectional edge, generated using images of the second optical cutting edge CL2, is the cross-sectional edge dcfincd on the back surface side of a cross-section of the rubber sheet 6. Therefore, the average height and the height standard deviation of the fourth cross-sectional edge can be regarded as the unevenness evaluation value of the back surface 6b of the rubber sheet 6.

With reference to FIG. 2, the image generation section 154 generates various images and causes the display unit 15 to display them. The various images include, for example, a 2D image of the rubber sheet 6 and a graph showing the height variation of a predetermined cross-sectional edge of the rubber sheet 6, as described in detail later. The display unit 15 is realized by a liquid crystal display or an organic light emitting diode display, for example.

The input unit 16 is a device for permitting the user to input a command (such as a command to measure the thickness and the width of the rubber sheet 6), for example. The input unit 16 is realized by a keyboard, a mouse, and a touch panel, for example.

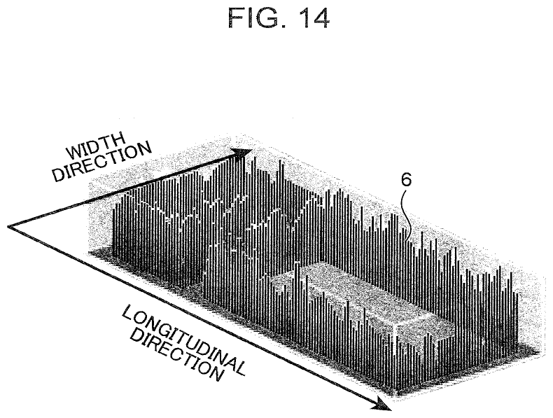

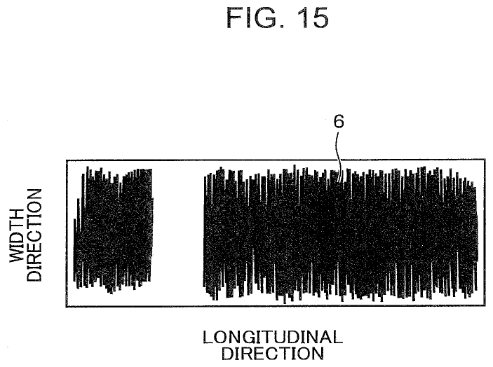

As described above, the image storage section 141 successively stores images of the first optical cutting edge CL1 and the second optical cutting edge CL2 formed on the rubber sheet 6 being fed from the roller extruder 3. The image generation section 154 generates various images using these images, specifically as follows. The image generation section 154 generates a 3D image of the rubber sheet 6 using images of the first optical cutting edge CL1 successively stored in the image storage section 141. FIG. 14 is a schematic view showing an example of the 3D image of the rubber sheet 6 generated by the image generation section 154. The image generation section 154 generates a 2D image of the rubber sheet 6 using images of the first optical cutting edge CL1 successively stored in the image storage section 141. FIG. 15 is a schematic view showing an example of the 2D image of the rubber sheet 6 generated by the image generation section 154. FIGS. 14 and 15 show images of the rubber sheet 6 seen from the front surface side. Although in FIG. 15, the image is displayed in two colors, it is actually displayed in gray scale. In the actual image, the white region in FIG. 15 is displayed in black and the black region in FIG. 15 is displayed in gray. Lighter gray represents higher portions and darker gray represents lower portions. The rubber sheet 6 is divided in two parts in the image. The image clearly shows one end and the other end of the rubber sheet 6 and the height variation (unevenness) of the front surface 6a of the rubber sheet 6.

The control processing unit 14 finds, in the 2D image of the rubber sheet 6 shown in FIG. 15, two coordinates where the height becomes less than a predetermined value and identifies them as the coordinates of one end and the other end of the rubber sheet 6. Using these coordinates, the control processing unit 14 calculates the width of the rubber sheet 6.

Although not shown, the image generation section 154 can use images of the second optical cutting edge CL2 successively stored in the image storage section 141 to generate a 3D image and a 2D image of the rubber sheet 6. These images will represent the rubber sheet 6 seen from the back surface side.

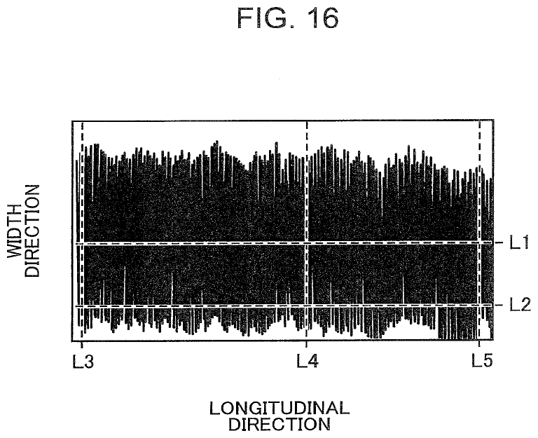

FIG. 16 is a schematic view showing another example of the 2D image of the rubber sheet 6 generated by the image generation section 154. The 2D image is an image of a rubber sheet 6 formed by extruding a batch of rolled material, the image being generated using images of the first optical cutting edge CL1 successively stored in the image storage section 141. The image generation section 154 causes the display unit 15 to display the 2D image of the rubber sheet 6 shown in FIG. 16. FIG. 16 is an image of the rubber sheet 6 seen from the front surface side. Although in FIG. 16, the image is displayed in two colors, it is actually displayed in gray scale. In the actual image, the white region in FIG. 16 is displayed in black and the black region in FIG. 16 is displayed in gray. Lighter gray represents higher portions and darker gray represents lower portions. Although not shown, the image generation section 154 can use images of the second optical cutting edge CL2 successively stored in the image storage section 141 to generate a 2D image of a rubber sheet 6 formed by extruding a batch of rolled material. This image will represent the rubber sheet 6 seen from the back surface side.

The user operates the input unit 16 to set a first straight line L and a second straight line L2 on the 2D image of the rubber sheet 6 shown in FIG. 16. The first straight line L1 is set to extend in the longitudinal direction of the 2D image of the rubber sheet 6 in the vicinity of the widthwise center of the rubber sheet 6. The second straight line L2 is set to extend in the longitudinal direction of the 2D image of the rubber sheet 6 in the vicinity of one end of the 2D image of the rubber sheet 6.

The user operates the input unit 16 to set, on the 2D image of the rubber sheet 6, a third straight line L3, a fourth straight line L4, and a fifth straight line L5 extending in the with direction of the rubber sheet 6. The fourth straight line L4 is set in the vicinity of the longitudinal center of the rubber sheet 6. The third straight line L3 is set on one end side of the 2D image of the rubber sheet 6 in the longitudinal direction of the rubber sheet 6. The fifth straight line L5 is set on the other end side of the 2D image of the rubber sheet 6 in the longitudinal direction of the rubber sheet 6.

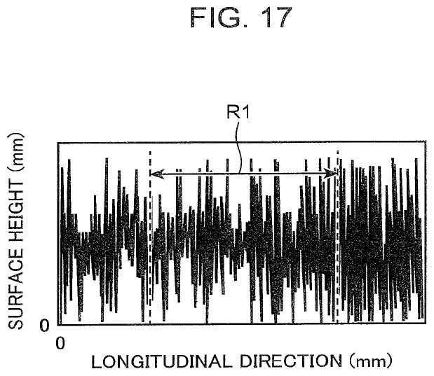

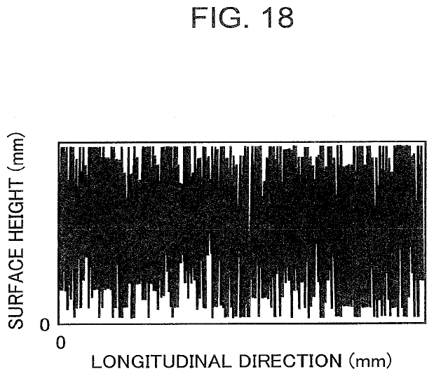

The image generation section 154 generates images shown in FIGS. 17 to 21 using the 2D image of the rubber sheet 6 shown in FIG. 16, and causes the display unit 15 to display them. FIG. 17 is a schematic graph showing the unevenness of the front surface 6a of the rubber sheet 6 at a cross-section taken along the first straight line L1. FIG. 18 is a schematic graph showing the unevenness of the front surface 6a of the rubber sheet 6 at a cross-section taken along the second straight line L2. In FIGS. 17 and 18, the horizontal axis represents the longitudinal direction of the rubber sheet 6 and the vertical axis represents the height of the front surface 6a of the rubber sheet 6. The height of the front surface 6a is indicated by black color. The height of the front surface 6a can be paraphrased as the height of a cross-sectional edge the rubber sheet 6. FIGS. 17 and 18 show change in the unevenness of the front surface 6a of the rubber sheet 6 seen in the longitudinal direction of the rubber sheet 6. The user can set a predetermined range R1 in the longitudinal direction by operating the input unit 16. The control processing unit 14 calculates the average height of the front surface 6a of the rubber sheet 6 and the height standard deviation of the rubber sheet 6 in the range R1, and causes the display unit to display the calculation results.

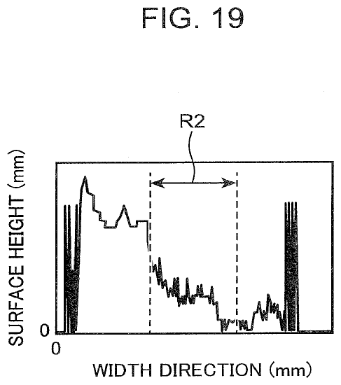

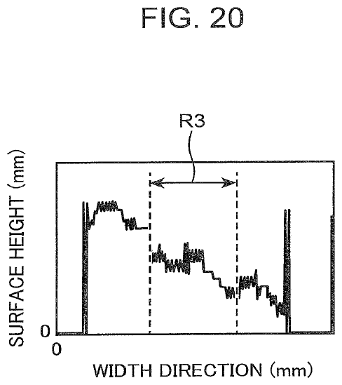

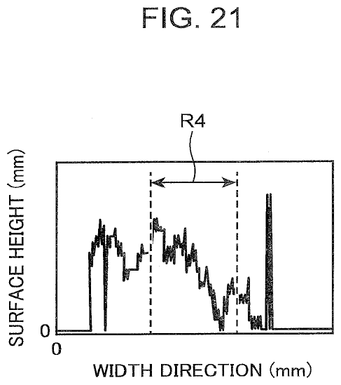

FIG. 19 is a schematic graph showing the unevenness of the front surface 6a of the rubber sheet 6 at a cross-section taken along the third straight line L3. FIG. 20 is a schematic graph showing the unevenness of the front surface 6a of the rubber sheet 6 at a cross-section taken along the fourth straight line L4. FIG. 21 is a schematic graph showing the unevenness of the front surface 6a of the rubber sheet 6 at a cross-section taken along the fifth straight line L5. In FIGS. 19 to 21, the horizontal axis represents the width direction of the rubber sheet 6 and the vertical axis represents the height of the front surface 6a of the rubber sheet 6. The height of the front surface 6a can be paraphrased as the height of a cross-sectional edge of the rubber sheet 6. FIGS. 19, 20, and 21 show, regarding the rubber sheet 6 formed by extruding a batch of rolled material, change in the unevenness of the front surface 6a of the rubber sheet 6 in the vicinity of the leading end, the vicinity of the center, and the vicinity of the rear end of the rubber sheet 6.

The user can set, for the graph of FIG. 19, a predetermined range R2 in the width direction of the rubber sheet 6 by operating the input unit 16. The control processing unit 14 calculates the average height of the front surface 6a of the rubber sheet 6 and the height standard deviation of the rubber sheet 6 in the range R2, and causes the display unit 15 to display the calculation results. Similarly, the user can set, for the graph of FIG. 20, a predetermined range R3 in the width direction of the rubber sheet 6 by operating the input unit 16. The control processing unit 14 calculates the average height of the front surface 6a of the rubber sheet 6 and the height standard deviation of the rubber sheet 6 in the range R3, and causes the display unit 15 to display the calculation results. The user can set, for the graph of FIG. 21, a predetermined range R4 in the width direction of the rubber sheet 6 by operating the input unit 16. The control processing unit 14 calculates the average height of the front surface 6a of the rubber sheet 6 and the height standard deviation of the rubber sheet 6 in the range R4, and causes the display unit 15 to display the calculation results.

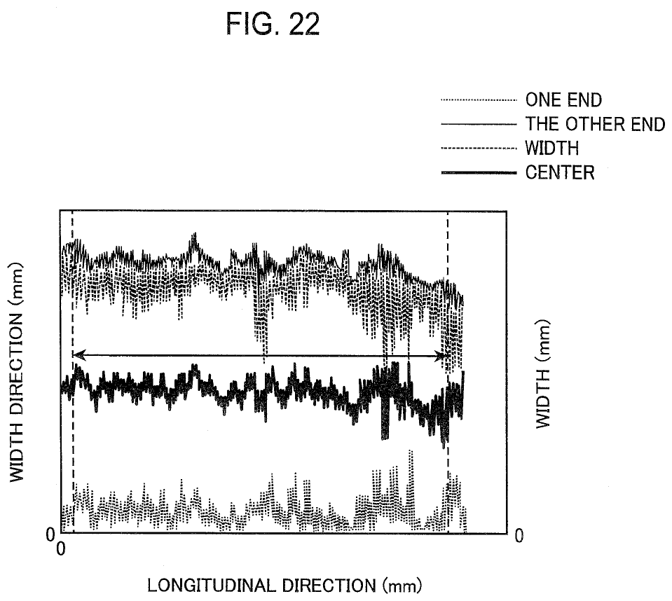

FIG. 22 is a schematic graph showing one end position and the other end position of the rubber sheet 6, the width of the rubber sheet 6, and the center position of the rubber sheet 6. These positions are considered in the width direction of the rubber sheet 6. The horizontal axis of the graph represents the longitudinal direction of the rubber sheet 6, the left vertical axis of the graph represents the width direction of the rubber sheet 6, and the right vertical axis of the graph represents the width of the rubber sheet 6. The control processing unit 14 generates this graph using the 2D image of the rubber sheet 6 shown in FIG. 16 and causes the display unit 15 to display this graph. Specifically, the control processing unit 14 calculates, using the 2D image of the rubber sheet 6 shown in FIG. 16, the position (coordinate) of one end and the position (coordinate) of the other end of the rubber sheet 6. The control processing unit 14 calculates, using the calculation results, the width and the center position (coordinate) of the rubber sheet 6. The graph of FIG. 22 shows, regarding the rubber sheet 6 formed by extruding a batch of rolled material, change in the width and the center position of the rubber sheet 6 from the start to the end of its formation. The change in the center position can be used to judge whether the rubber sheet 6 is fed in a meandering manner.

A modification of the rubber sheet monitoring apparatus 1 according to the embodiment will be described. The modification differs from the rubber sheet monitoring apparatus 1 according to the embodiment in that it does not include the second light source 12 and the second imaging unit 13 shown in FIG. 2. Therefore, the modification cannot obtain the second data D2. The modification calculates, similarly to the rubber sheet monitoring apparatus 1 according to the embodiment, the evaluation value for unevenness of a front surface 6a of a rubber sheet 6 and the width of the rubber sheet 6.

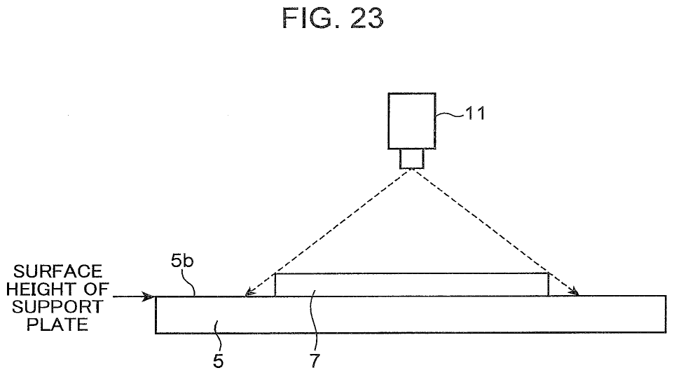

Since the modification cannot obtain the second data D2, a second calculation section 146 of the modification compares each first data D1 with a predetermined reference value to thereby calculate the thickness of the rubber sheet 6, specifically as follows. FIG. 23 is a diagram for explaining a principle for measuring the thickness of the rubber sheet 6 in the modification. In the modification, which does not capture images of a back surface 6b (FIG. 3) of the rubber sheet 6, there is no need to provide a gap 5a (FIG. 3) in a support plate 5. The modification obtains data similar to the first data D1 for a plate 7 having a known thickness, using the same method as that for obtaining the first data D1 of the rubber sheet 6. Since the thickness of the plate 7 is known, the control processing unit 14 calculates, using the obtained data and the thickness of the plate 7, the height of a front surface 5b of the support plate 5. The calculated height is used as the above-mentioned reference value. The control processing unit 14 stores the reference value (the height of the front surface 5b of the support plate 5) in advance. In the modification, the second calculation section 146 calculates the difference between the first data D1 and the reference value and identifies it as the thickness of the rubber sheet 6.

The modification, which does not require the second light source 12 and the second imaging unit 13, is suitable when the thickness of the rubber sheet 6 needs to be monitored simply. The modification makes it possible to reduce thickness errors by measuring the thickness of the rubber sheet 6 while a roller (not shown) presses (pushes) the rubber sheet 6. The modification, which does not require the formation of the gap 5a (FIG. 3) in the support plate 5, makes it possible to increase the flexibility of installation of the first imaging unit 11.

(Summary of Embodiment)

A rubber sheet monitoring apparatus according to a first aspect of the embodiment comprises: a first acquisition unit for successively acquiring images of a first optical cutting edge, synchronously with a feeding speed of a rubber sheet which is fed after having been formed into a sheet shape, the images of the first optical cutting edge being formed by irradiating one surface of the rubber sheet with a first sheet beam extending in a width direction of the rubber sheet; a second acquisition unit for successively acquiring images of a second optical cutting edge, synchronously with the feeding speed of the rubber sheet, the images of the second optical cutting edge being formed by irradiating the other surface of the rubber sheet with a second sheet beam extending in the width direction of the rubber sheet; a first generation unit for performing, for each of the successively acquired images of the first optical cutting edge, generation of first data representing height variation of a widthwise cross-sectional edge of the rubber sheet using the image of the first optical cutting edge, and performing, for each of the successively acquired images of the second optical cutting edge, generation of second data representing height variation of a widthwise cross-sectional edge of the rubber sheet using the image of the second optical cutting edge; a first calculation unit for calculating, using the first data, an unevenness evaluation value of the one surface of the rubber sheet; a second calculation unit for calculating, using first data and second data for a same cross-section, a thickness of the rubber sheet; and a third calculation unit for calculating, using the first data, a width of the rubber sheet.

A rubber sheet monitoring apparatus according to a second aspect of the embodiment comprises: a first acquisition unit for successively acquiring images of a first optical cutting edge, synchronously with a feeding speed of a rubber sheet which is fed after having been formed into a sheet shape, the images of the first optical cutting edge being formed on one surface of the rubber sheet by irradiating a first sheet beam extending in a width direction of the rubber sheet; a first generation unit for performing, for each of the successively acquired images of the first optical cutting edge, generation of first data representing height variation of a widthwise cross-sectional edge of the rubber sheet using the image of the first optical cutting edge; a first calculation unit for calculating, using the first data, an unevenness evaluation value of the one surface of the rubber sheet; a second calculation unit for calculating a thickness of the rubber sheet by comparing the first data and a predetermined reference value; and a third calculation unit for calculating, using the first data, a width of the rubber sheet.

The rubber sheet monitoring apparatus according to the first aspect of the embodiment calculates the thickness of the rubber sheet using the data (first data) for one surface of the rubber sheet and the data (second data) for the other surface of the rubber sheet. In contrast, the rubber sheet monitoring apparatus according to the second aspect of the embodiment calculates the thickness of the rubber sheet using the data (first data) for one surface of the rubber sheet. Since the first aspect of the embodiment calculates the thickness of the rubber sheet using the first data and the second data, it makes it possible to improve the accuracy of measuring the thickness of the rubber sheet. The second aspect of the embodiment, which does not need to generate the second data, makes it possible to simplify the measurement of the thickness of the rubber sheet.

In the rubber sheet monitoring apparatuses according to the first and second aspects of the embodiment, the first calculation unit calculates the unevenness evaluation value of one surface of the rubber sheet using each first data generated using the successively acquired images of the first optical cutting edge, and the third calculation unit calculates the width of the rubber sheet using each first data generated using the successively acquired images of the first optical cutting edge. Therefore, the rubber sheet monitoring apparatuses according to the first and second aspects of the embodiment makes it possible to calculate the unevenness evaluation value of one surface of the rubber sheet over its entirety and calculate the width of the rubber sheet over the entire surface of the rubber sheet.

In the rubber sheet monitoring apparatus according to the first aspect of the embodiment, the second calculation unit calculates, using first data and second data for the same cross-section (in other words, using first data and second data on the same longitudinal coordinate of the rubber sheet), the thickness of the rubber sheet at the cross-section. The second calculation unit performs the calculation using each of pieces of first data generated using the successively acquired images of the first optical cutting edge and each of pieces of second data generated using the successively acquired images of the second optical cutting edge. Therefore, the rubber sheet monitoring apparatus according to the first aspect of the embodiment makes it possible to calculate the thickness of the rubber sheet over its entire surface.

According to the rubber sheet monitoring apparatus according to the second aspect of the embodiment, the second calculation unit calculates the thickness of the rubber sheet using each of pieces of first data generated using the successively acquired images of the first optical cutting edge. Therefore, the rubber sheet monitoring apparatus according to the second aspect of the embodiment makes it possible to calculate the thickness of the rubber sheet over its entire surface.

In the rubber sheet monitoring apparatuses according to the first and second aspects of the embodiment, the first calculation unit calculates the unevenness evaluation value, for example, as follows. Regarding the cross-sectional edge of the rubber sheet corresponding to the first data, the first calculation unit calculates, using the first data, an average height of the cross-sectional edge and a height standard deviation of the cross-sectional edge and acquires the calculated average height and standard deviation as the unevenness evaluation value of the one surface of the rubber sheet.

In the rubber sheet monitoring apparatuses according to the first and second aspects of the embodiment, the third calculation unit calculates the width of the rubber sheet, for example, as follows. The third calculation unit extracts from the first data a range of heights less than the average height calculated by the first calculation unit and less than or equal to a predetermined second threshold value, then identifies from the extracted range coordinates of widthwise opposite ends of the rubber sheet 6, then calculates a distance between the identified coordinates of the opposite ends, and then calculates a distance on the rubber sheet corresponding to the calculated distance and acquires the calculated distance as the width of the rubber sheet.

In the rubber sheet monitoring apparatus according to the first aspect of the embodiment, the second calculation unit calculates the thickness of the rubber sheet, for example, as follows. The second calculation unit calculates a difference between the first data and the second data for the same cross-section and acquires the calculated difference as the thickness of the rubber sheet.

In the rubber sheet monitoring apparatus according to the second aspect of the embodiment, the second calculation unit calculates the thickness of the rubber sheet, for example, as follows. The reference value is a surface height of a support plate supporting the rubber sheet. The second calculation unit calculates a difference between the reference value and the first data and acquires the calculated difference as the thickness of the rubber sheet.

The first data represents the height of a cross-sectional edge defined on one surface of the rubber sheet, and the second data represents the height of a cross-sectional edge defined on the other surface of the rubber sheet. “The height of a cross-sectional edge” can be paraphrased as the shape of the edge defined by a cross-section and one surface or the other surface of the rubber sheet. The same applies hereinafter.

The first acquisition unit is configured, for example, in the form of a first imaging unit for successively capturing images of a first optical cutting edge formed by a first sheet beam incident on one surface of and extending in a width direction of a rubber sheet being fed from a roller extruder. The second acquisition unit is configured, for example, in the form of a second imaging unit for successively capturing images of a second optical cutting edge formed by a second sheet beam incident on the other surface of and extending in the width direction of the rubber sheet. The rubber sheet monitoring apparatus may be configured without the first imaging unit and the second imaging unit. In such a configuration, the acquisition unit is configured in the form of a first input unit (input interface) to which images of the first optical cutting edge successively captured by the first imaging unit are successively input, and the second acquisition unit is configured in the form of a second input unit (input interface) to which images of the second optical cutting edge successively captured by the second imaging unit are successively input.

In the above-described configuration, the rubber sheet contains silica.

As described above, in the case of a silica-containing rubber sheet, it is necessary to measure the thickness and other properties of the rubber sheet over its entire surface. The described configuration makes it possible to measure the thickness and other properties of the silica-containing rubber sheet over its entire surface.

In the above-described configuration, the rubber sheet monitoring apparatus further comprises: a first determination unit for determining whether the unevenness evaluation value calculated by the first calculation unit is within a predetermined first desired range; a second determination unit for determining whether the thickness of the rubber sheet calculated by the second calculation unit is within a predetermined second desired range; and a third determination unit for determining whether the width of the rubber sheet calculated by the third calculation unit is within a predetermined third desired range.

This configuration makes it possible to evaluate unevenness of one surface of the rubber sheet (good/bad evaluation of one surface of the rubber sheet), evaluate the thickness of the rubber sheet (good/bad evaluation of the thickness of the rubber sheet), and evaluate the width of the rubber sheet (good/bad evaluation of the width of the rubber sheet).

In the above-described configuration, the rubber sheet monitoring apparatus further comprises: a second generation unit for generating, using images of the first optical cutting edge successively acquired by the first acquisition unit, third data representing height of a first cross-sectional edge extending in a longitudinal direction of the rubber sheet, and for generating fourth data representing height of a second cross-sectional edge extending in the longitudinal direction of the rubber sheet and at a different coordinate in the width direction of the rubber sheet from the first cross-sectional edge; and a fourth determination unit for determining, when the first cross-sectional edge and the second cross-sectional edge both have heights exceeding a predetermined first threshold value at a same longitudinal coordinate, that the rubber sheet is bent.

When the rubber sheet is fed at a high speed, the rubber sheet is likely to bend (warp). It may happen that the heights of the first cross-sectional edge and the second cross-sectional edge extending in the longitudinal direction of the rubber sheet both exceed a predetermined first threshold value at the same longitudinal coordinate of the rubber sheet. The present inventors have considered that the reason why the rubber sheet is bent (warped) is a high feeding speed of the rubber sheet. According to this configuration, when the first cross-sectional edge and the second cross-sectional edge both have heights exceeding the first threshold value at the same longitudinal coordinate of the rubber sheet, it is determined that the rubber sheet is bent (warped).

The second generation unit may generate the third data and the fourth data using images of the second optical cutting edge.

In the above-described configuration, the rubber sheet monitoring apparatus further comprises: a fourth calculation unit for calculating, using the first data, one coordinate indicating a position of one end of the rubber sheet in the width direction and the other coordinate indicating a position of the other end of the rubber sheet, and calculating an intermediate coordinate between the one coordinate and the other coordinate as a center of the rubber sheet.

This configuration makes it possible to calculate the center of the rubber sheet. Monitoring the displacement of the center of the rubber sheet makes it possible to monitor whether the rubber sheet is fed in a meandering manner.

The fourth calculation unit may calculate one coordinate and the other coordinate using the second data.

In the first aspect of the embodiment, each image of the first optical cutting edge is generated using specular reflection of the first sheet beam and each image of the second optical cutting edge is generated using specular reflection of the second sheet beam. In the second aspect of the embodiment, each image of the first optical cutting edge is generated using specular reflection of the first sheet beam.

When the surface of the rubber sheet has mirror-like properties, the intensity of diffuse reflection is low. Thus, using an image of the first optical cutting edge generated using diffuse reflection of the first sheet beam and an image of the second optical cutting edge generated using diffuse reflection of the second sheet beam will make the accuracy of measuring the thickness of the rubber sheet low. In contrast, when the surface of the rubber sheet has mirror-like properties, the intensity of specular reflection is high. Thus, using the image of the first optical cutting edge generated using specular reflection of the first sheet beam and the image of the second optical cutting edge generated using specular reflection of the second sheet beam makes it possible to measure the thickness of the rubber sheet at a high accuracy. Therefore, this configuration is suitable when the surface of the rubber sheet has mirror-like properties.

A rubber sheet monitoring method according to a third aspect of the embodiment comprises: a first acquisition step of successively acquiring images of a first optical cutting edge, synchronously with a feeding speed of a rubber sheet which is fed after having been formed into a sheet shape, the images of the first optical cutting edge being formed by irradiating one surface of the rubber sheet with a first sheet beam extending in a width direction of the rubber sheet; a second acquisition step of successively acquiring images of a second optical cutting edge, synchronously with the feeding speed of the rubber sheet, the images of the second optical cutting edge being formed by irradiating the other surface of the rubber sheet with a second sheet beam extending in the width direction of the rubber sheet; a first generation step of performing, for each of the successively acquired images of the first optical cutting edge, generation of first data representing height variation of a widthwise cross-sectional edge of the rubber sheet using the image of the first optical cutting edge, and performing, for each of the successively acquired images of the second optical cutting edge, generation of second data representing height variation of a widthwise cross-sectional edge of the rubber sheet using the image of the second optical cutting edge; a first calculation step of calculating, using the first data, an unevenness evaluation value of the one surface of the rubber sheet; a second calculation step of calculating, using first data and second data for a same cross-section, a thickness of the rubber sheet; and a third calculation step of calculating, using the first data, a width of the rubber sheet.

The rubber sheet monitoring method according to the third aspect of the embodiment defines the invention defined as the rubber sheet monitoring apparatus according to the first aspect of the embodiment in terms of a method and, therefore, provides the same advantageous effects as the rubber sheet monitoring apparatus according to the first aspect of the embodiment.

A rubber sheet monitoring method according to a fourth aspect of the embodiment comprises: a first acquisition step of successively acquiring images of a first optical cutting edge, synchronously with a feeding speed of a rubber sheet which is fed after having been formed into a sheet shape, the images of the first optical cutting edge being formed by irradiating one surface of the rubber sheet with a first sheet beam extending in a width direction of the rubber sheet; a first generation step of performing, for each of the successively acquired images of the first optical cutting edge, generation of first data representing height variation of a widthwise cross-sectional edge of the rubber sheet using the image of the first optical cutting edge; a first calculation step of calculating, using the first data, an unevenness evaluation value of the one surface of the rubber sheet; a second calculation step of calculating a thickness of the rubber sheet by comparing the first data and a predetermined reference value; and a third calculation step of calculating, using the first data, a width of the rubber sheet.

The rubber sheet monitoring method according to the fourth aspect of the embodiment defines the invention defined as the rubber sheet monitoring apparatus according to the second aspect of the embodiment in terms of a method and, therefore, provides the same advantageous effects as the rubber sheet monitoring apparatus according to the second aspect of the embodiment.

1: A rubber sheet monitoring apparatus, comprising:
a first acquisition unit for successively acquiring images of a first optical cutting edge, synchronously with a feeding speed of a rubber sheet which is fed after having been formed into a sheet shape, the images of the first optical cutting edge being formed by irradiating one surface of the rubber sheet with a first sheet beam extending in a width direction of the rubber sheet;
a second acquisition unit for successively acquiring images of a second optical cutting edge, synchronously with the feeding speed of the rubber sheet, the images of the second optical cutting edge being formed by irradiating other surface of the rubber sheet with a second sheet beam extending in the width direction of the rubber sheet;
a first generation unit for performing, for each of the successively acquired images of the first optical cutting edge, generation of first data representing height variation of a widthwise cross-sectional edge of the rubber sheet using the image of the first optical cutting edge, and performing, for each of the successively acquired images of the second optical cutting edge, generation of second data representing height variation of a widthwise cross-sectional edge of the rubber sheet using the image of the second optical cutting edge;
a first calculation unit for calculating, using the first data, an unevenness evaluation value of the one surface of the rubber sheet;
a second calculation unit for calculating, using first data and second data for a same cross-section, a thickness of the rubber sheet; and
a third calculation unit for calculating, using the first data, a width of the rubber sheet.

2: A rubber sheet monitoring apparatus, comprising:
a first acquisition unit for successively acquiring images of a first optical cutting edge, synchronously with a feeding speed of a rubber sheet which is fed after having been formed into a sheet shape, the images of the first optical cutting edge being formed by irradiating one surface of the rubber sheet with a first sheet beam extending in a width direction of the rubber sheet;
a first generation unit for performing, for each of the successively acquired images of the first optical cutting edge, generation of first data representing height variation of a widthwise cross-sectional edge of the rubber sheet using the image of the first optical cutting edge;
a first calculation unit for calculating, using the first data, an unevenness evaluation value of the one surface of the rubber sheet;
a second calculation unit for calculating a thickness of the rubber sheet by comparing the first data and a predetermined reference value; and
a third calculation unit for calculating, using the first data, a width of the rubber sheet.

3: The rubber sheet monitoring apparatus according to claim 1, wherein
the rubber sheet comprises silica.

4: The rubber sheet monitoring apparatus according to claim 1, further comprising:
a first determination unit for determining whether the unevenness evaluation value calculated by the first calculation unit is within a predetermined first desired range;
a second determination unit for determining whether the thickness of the rubber sheet calculated by the second calculation unit is within a predetermined second desired range; and
a third determination unit for determining whether the width of the rubber sheet calculated by the third calculation unit is within a predetermined third desired range.

5: The rubber sheet monitoring apparatus according to claim 1, further comprising:
a second generation unit for generating, using images of the first optical cutting edge successively acquired by the first acquisition unit, third data representing height of a first cross-sectional edge extending in a longitudinal direction of the rubber sheet, and for generating fourth data representing height of a second cross-sectional edge extending in the longitudinal direction of the rubber sheet and at a different coordinate in the width direction of the rubber sheet from the first cross-sectional edge; and
a fourth determination unit for determining, when the first cross-sectional edge and the second cross-sectional edge both have heights exceeding a predetermined first threshold value at a same longitudinal coordinate, that the rubber sheet is bent.

6: The rubber sheet monitoring apparatus according to claim 1, further comprising:
a fourth calculation unit for calculating, using the first data, one coordinate indicating a position of one end of the rubber sheet in the width direction and other coordinate indicating a position of other end of the rubber sheet, and calculating an intermediate coordinate between the one coordinate and the other coordinate as a center of the rubber sheet.

7: The rubber sheet monitoring apparatus according to claim 1, wherein
regarding the cross-sectional edge of the rubber sheet corresponding to the first data, the first calculation unit calculates, using the first data, an average height of the cross-sectional edge and a height standard deviation of the cross-sectional edge and acquires the calculated average height and standard deviation as the unevenness evaluation value of the one surface of the rubber sheet.

8: The rubber sheet monitoring apparatus according to claim 7, wherein
the third calculation unit extracts from the first data a range of heights less than the average height calculated by the first calculation unit and less than or equal to a predetermined second threshold value, then identifies from extracted range coordinates of widthwise opposite ends of the rubber sheet, then calculates a distance between identified coordinates of the opposite ends, and then calculates a distance on the rubber sheet corresponding to a calculated distance and acquires the calculated distance as the width of the rubber sheet.

9: The rubber sheet monitoring apparatus according to claim 1, wherein
the second calculation unit calculates a difference between the first data and the second data for the same cross-section and acquires a calculated difference as the thickness of the rubber sheet.

10: The rubber sheet monitoring apparatus according to claim 2, wherein
the reference value is a surface height of a support plate supporting the rubber sheet, and
the second calculation unit calculates a difference between the reference value and the first data and acquires a calculated difference as the thickness of the rubber sheet.

11: The rubber sheet monitoring apparatus according to claim 1, wherein
each image of the first optical cutting edge is generated using specular reflection of the first sheet beam and
each image of the second optical cutting edge is generated using specular reflection of the second sheet beam.

12: The rubber sheet monitoring apparatus according to claim 2, wherein
each image of the first optical cutting edge is generated using specular reflection of the first sheet beam.

13: A rubber sheet monitoring method, comprising:
a first acquisition step of successively acquiring images of a first optical cutting edge, synchronously with a feeding speed of a rubber sheet which is fed after having been formed into a sheet shape, the images of the first optical cutting edge being formed by irradiating one surface of the rubber sheet with a first sheet beam extending in a width direction of the rubber sheet;
a second acquisition step of successively acquiring images of a second optical cutting edge, synchronously with the feeding speed of the rubber sheet, the images of the second optical cutting edge being formed by irradiating other surface of the rubber sheet with a second sheet beam extending in the width direction of the rubber sheet;
a first generation step of performing, for each of the successively acquired images of the first optical cutting edge, generation of first data representing height variation of a widthwise cross-sectional edge of the rubber sheet using the image of the first optical cutting edge, and performing, for each of the successively acquired images of the second optical cutting edge, generation of second data representing height variation of a widthwise cross-sectional edge of the rubber sheet using the image of the second optical cutting edge;
a first calculation step of calculating, using the first data, an unevenness evaluation value of the one surface of the rubber sheet;
a second calculation step of calculating, using first data and second data for a same cross-section, a thickness of the rubber sheet; and
a third calculation step of calculating, using the first data, a width of the rubber sheet.

14: A rubber sheet monitoring method, comprising:
a first acquisition step of successively acquiring images of a first optical cutting edge, synchronously with a feeding speed of a rubber sheet which is fed after having been formed into a sheet shape, the images of the first optical cutting edge being formed by irradiating one surface of the rubber sheet with a first sheet beam extending in a width direction of the rubber sheet;
a first generation step of performing, for each of the successively acquired images of the first optical cutting edge, generation of first data representing height variation of a widthwise cross-sectional edge of the rubber sheet using the image of the first optical cutting edge;
a first calculation step of calculating, using the first data, an unevenness evaluation value of the one surface of the rubber sheet;
a second calculation step of calculating a thickness of the rubber sheet by comparing the first data and a predetermined reference value; and
a third calculation step of calculating, using the first data, a width of the rubber sheet.

15: The rubber sheet monitoring apparatus according to claim 2, wherein
the rubber sheet comprises silica.

16: The rubber sheet monitoring apparatus according to claim 2, further comprising:
a first determination unit for determining whether the unevenness evaluation value calculated by the first calculation unit is within a predetermined first desired range;
a second determination unit for determining whether the thickness of the rubber sheet calculated by the second calculation unit is within a predetermined second desired range; and
a third determination unit for determining whether the width of the rubber sheet calculated by the third calculation unit is within a predetermined third desired range.

17: The rubber sheet monitoring apparatus according to claim 2, further comprising:
a second generation unit for generating, using images of the first optical cutting edge successively acquired by the first acquisition unit, third data representing height of a first cross-sectional edge extending in a longitudinal direction of the rubber sheet, and for generating fourth data representing height of a second cross-sectional edge extending in the longitudinal direction of the rubber sheet and at a different coordinate in the width direction of the rubber sheet from the first cross-sectional edge; and
a fourth determination unit for determining, when the first cross-sectional edge and the second cross-sectional edge both have heights exceeding a predetermined first threshold value at a same longitudinal coordinate, that the rubber sheet is bent.

18: The rubber sheet monitoring apparatus according to claim 2, further comprising:
a fourth calculation unit for calculating, using the first data, one coordinate indicating a position of one end of the rubber sheet in the width direction and other coordinate indicating a position of other end of the rubber sheet, and calculating an intermediate coordinate between the one coordinate and the other coordinate as a center of the rubber sheet.

19: The rubber sheet monitoring apparatus according to claim 2, wherein
regarding the cross-sectional edge of the rubber sheet corresponding to the first data, the first calculation unit calculates, using the first data, an average height of the cross-sectional edge and a height standard deviation of the cross-sectional edge and acquires the calculated average height and standard deviation as the unevenness evaluation value of the one surface of the rubber sheet.

20: The rubber sheet monitoring apparatus according to claim 19, wherein
the third calculation unit extracts from the first data a range of heights less than the average height calculated by the first calculation unit and less than or equal to a predetermined second threshold value, then identifies from extracted range coordinates of widthwise opposite ends of the rubber sheet, then calculates a distance between identified coordinates of the opposite ends, and then calculates a distance on the rubber sheet corresponding to a calculated distance and acquires the calculated distance as the width of the rubber sheet.
